(19) United States
(12) Patent Application Publication
(10) Pub. No.: US 2013/0100126 A1
(43) Pub. Date: Apr. 25, 2013

(54) THREE-DIMENSIONAL DISPLAY APPARATUS AND METHOD OF CONTROLLING THE SAME

(71) Applicant: Samsung Electronics Co., Ltd., Gyeonggi-do (KR)

(72) Inventors: Sung-Soon KIM, Seoul (KR); Yong-Chan KEH, Seoul (KR); Joong-Wan PARK, Gyeonggi-do (KR); Ho-Min LEE, Gyeonggi-do (KR)

(73) Assignee: Samsung Electronics Co., Ltd., Gyeonggi-do (KR)

(21) Appl. No.: 13/659,591

(22) Filed: Oct. 24, 2012

(30) Foreign Application Priority Data
Oct. 24, 2011 (KR) 10-2011-0108775

(51) Int. Cl. G06T 15/00

(52) U.S. Cl. 345/419

(57) ABSTRACT

Methods and apparatus for displaying a 3D are provided that inlucde a display unit formed of a transparent material for displaying a 2D image. An input image that includes 3D display information is received. The 3D display information is transformed into at least one piece of 2D display information by analyzing the input image. At least one 2D subframe image is displayed based on the 2D display information while the display unit is rotating.

### PRIORITY

This application claims priority under 35 U.S.C. §119(a) to a Korean Patent Application filed in the Korean Intellectual Property Office on Oct. 24, 2011, and assigned Serial No. 10-2011-0108775, the entire disclosure of which is incorporated herein by reference.

### BACKGROUND OF THE INVENTION

1. Field of the Invention

The present invention relates generally to a Three-Dimensional (3D) display apparatus and method of controlling the same, and more particularly, to a volumetric 3D display apparatus and method of controlling the same using rotation of a transparent display means.

2. Description of the Related Art

3D display devices are largely classified into glasses, glasses-free, volumetric, and holographic 3D display devices.

Glasses or glasses-free 3D display devices enable a viewer to feel sense of dimension by separately providing Two-Dimensional (2D) images, having a visual disparity therebetween, for left and right eyes of the user. However, the glasses type requires the viewer to wear additional accessories, such as, for example, polarization glasses, to see 3D images. In addition, the glasses-free type has to set an appropriate position in order to view 3D images, because visual points are discontinuously separated and fixed. Furthermore, the glasses and glasses-free types are limited in that both only reproduce depth information of an object, while preventing an observer from viewing images of the object from several directions.

Due to the shortcomings of the glasses and glasses-free types, many kinds of volumetric 3D display devices have been developed to display substantially perfect 3D images.

A first kind of volumetric 3D display device implements 3D images by adding directivity by means of a slit to fit each visual point, while displaying 2D images by dividing the points in a direction of 360 degrees. However, this first kind of volumetric 3D display device has a defect of decreasing the brightness of an entire image, because it uses a method of controlling to display a single image at a particular point. This limits exposure time of images, i.e., pixels. This first kind of volumetric 3D display device also requires high velocity bodies of revolution, such that the product of the number of visual points is multiplied by the number of frames per second by 60, thus providing an increase in implementation complexity. Furthermore, this first kind of volumetric 3D display device also has a resolution problem in implementing images with Light Emitting Diode (LED) arrays.

A second kind of volumetric 3D display device projects an image at a point from an upper projector onto a Holographic Optical Element (HOE) diffusion mirror. This second kind of volumetric 3D display device is implemented to obtain a 3D image by rotating the mirror, forming in and projecting onto the projector an image for each visual point, securing the directivity toward the visual point at HOE. However, this second kind of volumetric 3D display device requires a high performance projector and is limited in its high velocity body of revolution. Furthermore, an optical modulator projector capable of high-resolution, high-velocity modulation is also required, thus increasing the cost.

A third kind of volumetric 3D display device forms a 3D image by projecting an image for each visual point onto a translucent screen using a projector and a rotating mirror and rotating the screen. This third kind of volumetric 3D display device also requires a high performance projector, sophisticated tools for the high-velocity body of revolution, and a complex driver for the mirror.

### SUMMARY OF THE INVENTION

The present invention has been made to address at lesat the above problems and/or disadvantages and to provide at least the advantages described below. Accordingly, an aspect of the present invention provides a 3D display apparatus and method of controlling the same by which a volumetric 3D image is formed by rotating a single transparent display device.

In accordance with an embodiment of the present invention, a 3D display apparatus is provided that includes a display unit formed of a transparent material for displaying a 2D image. The 3D display apparatus also includes an interface unit for receiving an input image that includes 3D display information, and a rotation driver coupled to the display unit for rotating the display unit at a predetermined angular velocity within a predetermined period. The 3D display apparatus further includes a controller for transforming the 3D display information into at least one piece of 2D display information by analyzing the input image, and controlling the display unit to display at least one 2D subframe image while the display unit is rotating.

In accordance with another embodiment of the present invention, a 3D display apparatus is provided that includes a display unit formed of a transparent material for displaying a 2D image, and a driver unit for creating and outputting the 2D image to the display unit by generating graphic data according to a predetermined standard. The 3D display apparatus further includes a fixed driver for rotating the display unit at a predetermined angular velocity, transforming 3D display information of an input image into at least a piece of 2D display information by analyzing the input image, and outputting at least one 2D subframe image to the display unit so that the display unit displays the at least one 2D subframe image based on the 2D display information while the display unit is rotating.

In accordance with a further embodiment of the present invention, a method is provided for controlling a 3D display apparatus that includes a display unit formed of a transparent material for displaying a 2D image. An input image that includes 3D display information is received. The 3D display information is transformed into at least one piece of 2D display information by analyzing the input image. At least one 2D subframe image is displayed based on the 2D display information while the display unit is rotating.

### BRIEF DESCRIPTION OF THE DRAWINGS

The above and other aspects, features, and advantages of the present invention will be more apparent from the following detailed description when taken in conjunction with the accompanying drawings in which:

FIG. 1A is diagram illusrtating a perspective view of a 3D display apparatus, according to an embodiment of the present invention;

FIG. 1B is a diagram illustrating a plane view of the 3D display apparatus of FIG. 1A, according to an embodiment of the present invention;

FIG. 1C is a diagram illustrating a perspective view of the 3D display apparatus, according to another embodiment of the present invention;

FIG. 2 is a block diagram illustrating the 3D display apparatus, according to an embodiment of the present invention;

FIG. 3A is a diagram illustrating a 3D image in voxel coordinates, according to an embodiment of the present invention;

FIGS. 3B to 3D are diagrams illustrating 2D subframe images transformed from the 3D image of FIG. 3A, according to an embodiment of the present invention;

FIG. 4 is a block diagram illustrating the 3D display apparatus, according to another embodiment of the present invention;

FIG. 5 is a block diagram illustrating the 3D display apparatus, according to another embodiment of the present invention;

FIG. 6 is a block diagram illustrating the 3D display apparatus, according to another embodiment of the present invention;

FIG. 7 is a diagram illustrating synchronization, according to an embodiment of the present invention; and

FIG. 8 is a flowchart illusrtating a method of controlling the 3D display apparatus, according to an embodiment of the present invention.

### DETAILED DESCRIPTION OF EMBODIMENTS OF THE INVENTION

Embodiments of the present invention are described in detail with reference to the accompanying drawings. The same or similar components may be designated by the same or similar reference numerals although they are illustrated in different drawings. Detailed descriptions of constructions or processses known in the art may be omitted to avoid obscuring the subject matter of the present invention.

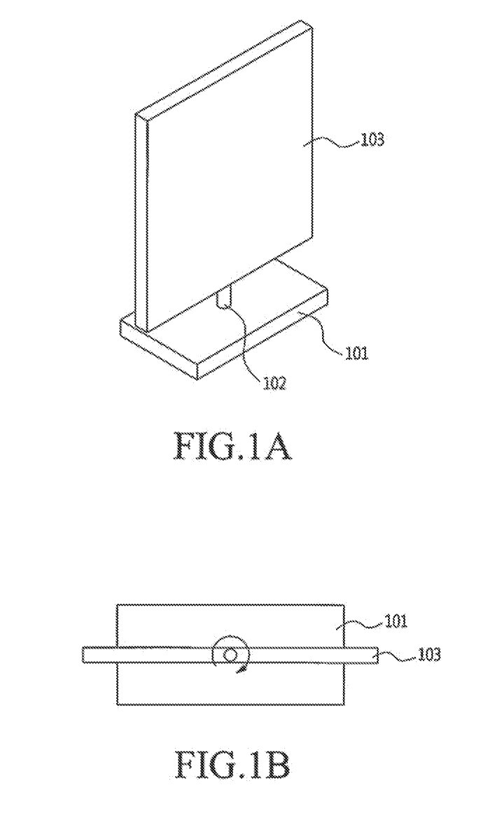

FIG. 1A is diagram illustrating a perspective view of a 3D display apparatus, according to an embodiment of the present invention. Referring to FIG. 1A, the 3D display apparatus includes a fixed driver 101, a rotation connector 102, and a display unit 103.

The fixed driver 101 is a means for supporting the rotation connector 102 and the display unit 103. The fixed driver 101 is directly coupled to the rotation connector 102, which is built orthogonal to the fixed driver 101. The fixed driver 101 includes a rotation means to rotate the rotation connector 102 at a predetermined angular velocity within a predetermined period. The rotating means may be implemented with well-known servos or motors, but is not limited thereto.

FIG. 1B is a diagram illusrtating a plane view of the 3D display apparatus of FIG. 1A, according to an embodiment of the present invention. Referring to FIG. 1B, the display unit 103 is rotated by means of the rotation connector 102 connected thereto. The axis of ration of the display unit 103 lies in the center of the cross-section of the display unit 103. In FIG. 1B, a rotational direction of the display unit 103 is illustrated as clockwise, however, embodiments of the present invention are not limited thereto.

The fixed driver 101 analyzes an input image input through a predetermined interfacing method or stored therein, and converts the image into 2D display information. More specifically, the fixed driver 101 converts 3D display information of a frame image into 2D display information, and displays timing information of at least one 2D subframe image, which is described in greater detail below.

The fixed driver 101 controls the display unit 103 to display the at least one 2D subframe image while the display unit 103 is rotating, based on the converted 2D display information and the display timing information.

The fixed driver 101 rotates the rotation connector 102 at a predetermined angular velocity within a period, and the rotation connector 102 rotates the display unit 103 at the same angular velocity within the same period. The rotation connector 102 is implemented as a means for connecting the fixed driver 101 and the display unit 103, and relays a control signal output by the fixed driver 101 to the display unit 103. The rotation connector 102 may relay the signal wiredly or wirelessly, and may be implemented with a SLIP ring in an embodiment of the present invention.

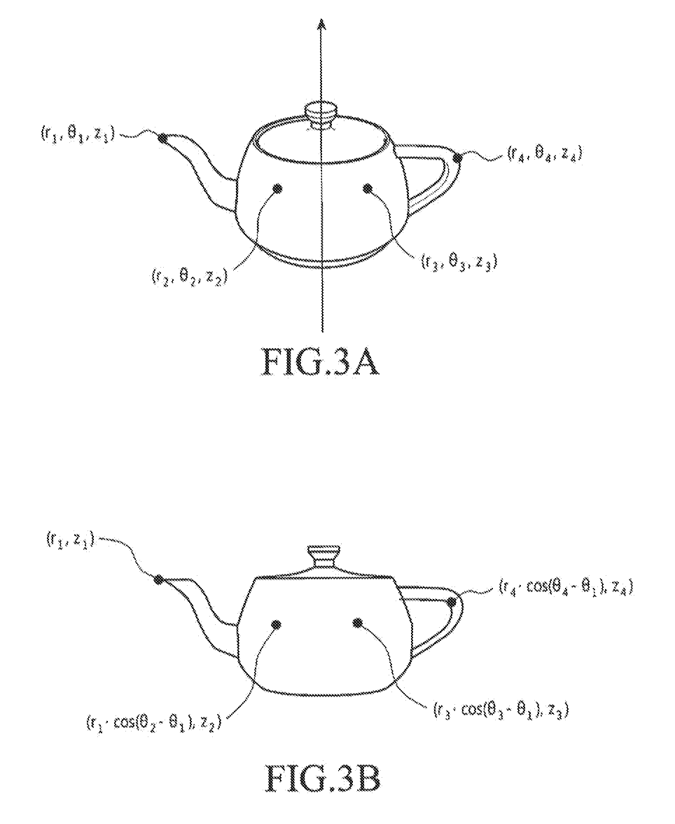

The display unit 103 displays the at least one 2D subframe image while being rotated, based on the control signal relayed through the rotation connector 102. The display unit 103 displays the predetermined number of 2D subframe images while being rotated, thus creating a single 3D frame image for a half rotation, as described in greater detail below with reference to FIGS. 3A through 3D.

The display unit 103 is formed of a transparent material, and may be implemented with Organic Light Emitting Diodes (OLEDs) in an embodiment of the present invention.

As described above, the 3D display apparatus of the present invention creates the 3D frame image according to the rotation of the display unit 103 without an additional means, such as a projector or a diffusion mirror.

FIG. 1C is a diagram illustrating a perspective view of the 3D display apparatus, according to another embodiment of the present invention. The 3D display apparatus includes a display unit 104, a rotation connector 105, and a fixed driver 106. In contrast to FIG. 1A, the 3D display apparatus of FIG. 1C has an axis of rotation that is disposed toward an end or edge of the display unit 104.

The display unit 104 displays the 2D subframe image while being rotated, and, as opposed to the display unit 103 of FIG. 1A, which creates a 3D subframe image for a half rotation, it creates a 3D subframe image for one rotation.

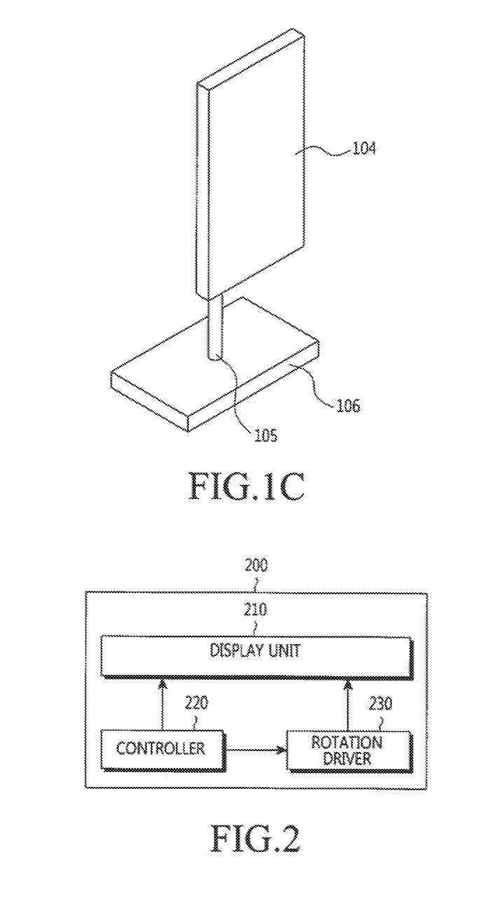

FIG. 2 is a block diagram illustrating a 3D display apparatus 200, according to an embodiment of the present invention. The 3D display apparatus 200 includes a display unit 210, a controller 220, and a rotation driver 230.

The display unit 210 is formed of a transparent material, as described above, and timely displays 2D subframe images input from the controller 220. The display unit 210 is directly connected to the rotation driver 230 and is rotated according to the rotation of the rotation driver 230. Accordingly, the display unit 210 timely displays the 2D subframe images while being rotated, thus creating a single 3D frame image for a half rotation or for one rotation.

The controller 220 analyzes the input image having an input or extracted 3D display information. The controller 220 selects an image source to be used as a display source after the analysis of the input image, and extracts the 3D display information from the selected image source. Obtaining 3D display information from 2D display information is not limited to the extraction of the 3D display information in the controller 220. Other known methods may be utilized to create the 3D display information from the 2D display information.

The controller 220 represents the extracted or created 3D display information in voxel coordinates of a 3D image. The representation in the voxel coordinates may be in a cylindrical coordinate system where coordinates of a marked point of each voxel of the 3D frame image are assigned to the voxel.

The controller 220 converts information of the voxel coordinates into information 10 of at least one set of 2D pixel coordinates. As described above, in order to create the 3D frame image, a plurality of 2D subframe images are required. Thus, information on a piece of voxel coordinates is converted into information on at least one set of 2D pixel coordinates, which is described in greater detail below with respect to FIGS. 3A through 3D.

The controller 220 maps display timings of at least one 2D subframe image. Specifically, the controller 220 maps a 2D subframe image that corresponds to an angle of the display unit 210 at a display timing to the display timing, which is described in greater detail below with respect to FIGS. 3A through 3D.

The controller 220 controls the display unit 210 to display the transformed 2D subframe image at the corresponding display timing. The controller 220 may be implemented as a Central Processing Unit (CPU), a microprocessor, or a mini-computer. The controller 220 may be implemented in a form embedded in the fixed driver 101 of FIG. 1A.

The rotation driver 230 rotates the display unit 210 at a predetermined angular velocity within a predetermined period, under the control of the controller 220. The rotation driver 230 relays various signals output from the controller 220 to the display unit 210 for output.

FIGS. 3A to 3D are diagrams illusrtating how to convert voxel coordinates into at least one 2D subframe image, according to an embodiment of the present invention.

As described above, the controller 220 receives an input image having the 3D display information. The controller 220 analyzes the input image, selects an image source to be used as a display source, and extracts the 3D display information from the selected image source. The controller 220 analyzes the 3D display information and represent the 3D image in voxel coordinates. FIG. 3A is a diagram illustrating the 3D image in voxel coordinates, according to an embodiment of the present invention.

In FIG. 3A, the 3D image represented in voxel coordinates has the shape of a kettle in which an axis is formed to pass through the knob of the lid of the kettle. The voxel coordinates of the embodiment of the present invention may be in the cylindrical coordinate system, and four voxel coordinates are shown in the 3D image. The 3D mage includes a first voxel (r1,θ1,z1), a second voxel (r2,θ2,z2), a third voxel (r3,θ3,z3), and a fourth voxel (r4,θ4,z4).

The controller 220 converts the 3D image into at least one 2D subframe image. FIGS. 3B to 3D are diagrams illustrating 2D subframe images transformed from the 3D image of FIG. 3A, according to an embodiment of the present invention.

The controller 220 creates a 2D subframe image as a first 2D subframe image, as shown in FIG. 3B. The first 2D subframe image includes first to fourth pixels corresponding to the first to fourth voxels of FIG. 3A. The first pixel (r1,z1) corresponds to the first voxel (r1,θ1,z1); the second pixel (r2cos(θ2−θ1),z2) corresponds to the second voxel (r2,θ2,z2); the third pixel (r3cos(θ3−θ1),z3) corresponds to the third voxel (r3,θ3,z3); and the fourth pixel (r4cos(θ4−θ1),z4) corresponds to the forth voxel (r4,θ4,z4).

The controller 220 timely maps the first 2D subframe image to be displayed first.

The controller 220 creates a 2D subframe image as a second 2D subframe image, as shown in FIG. 3C. The 2D subframe image includes first and second pixels corresponding to the first and second voxels of FIG. 3A. The first pixel (r1cos(θ−θ1),z1) corresponds to the first voxel (r1,θ1,z1), and the second pixel (r2cos(θ−θ1),z2) corresponds to the second voxel (r2,θ2,z2). Here, a value of θ−θ1 may be 90°, and thus, a value of r of the first pixel may be 0. θ is an angle that corresponds to a particular point in time, and, with a lapse of time t since a new rotation period has begun, is related to the time t as shown in Equation (1) below. θ is referred to as a display angle.

θ=w×t (1)

In Equation (1), w is a rotational angular velocity.

However, there are no pixels found corresponding to the third and fourth voxels. The controller 220 controls display of a pixel only if Equation (2) is satisfied.

|θ−θx|<90° (2)

In Equation (2), θ is an angle corresponding to a lapse of time t since a new rotation period has begun, and θx is an angular component of each voxel.

With respect to the third and fourth voxels of FIG. 3A, because respective values of |θ−θ3| and |θ−θ4| exceed 90°, pixels that correspond to the third and fourth voxels are not shown in FIG. 3C.

The controller 220 timely maps the second 2D subframe image to be displayed second.

The controller 220 creates a 2D subframe image as a third 2D subframe image, as shown in FIG. 3D. The 2D subframe image includes first and fourth pixels corresponding to the first and fourth voxels of FIG. 3A. The first pixel (r1cos(θ1−θ4),z1) corresponds to the first voxel (r1,θ1,z1), and the fourth pixel (r4,z4) corresponds to the fourth voxel (r4,θ4,z4). The second and third voxels do not satisfy Equation (2), and thus, are not shown in the third 2D subframe image.

The controller 220 timely maps the third 2D subframe image to be displayed third.

The number of the 2D subframe images of FIGS. 3B to 3D are for illustration, and the controller 220 may create more 2D subframe images. The number of 2D subframe images to be used to create a 3D frame image is not limited and may vary.

Under control of the controller 220, the display unit 210 displays the first, second, and third 2D subframe images in sequence, thus creating a 3D frame image.

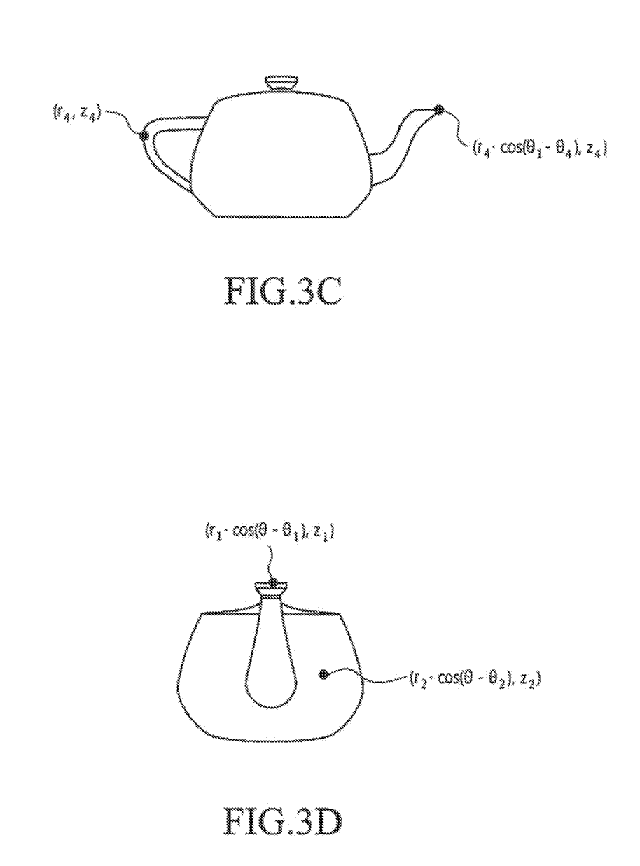

FIG. 4 is a block diagram illustrating a 3D display apparatus, according to another embodiment of the present invention.

Referring to FIG. 4, a 3D display apparatus 400 includes a display unit 410, a driver unit 420, a controller 430, and an interface unit 440.

The display unit 410 is formed of a transparent material and performs 2D display, as described with respect to FIG. 1A or FIG. 2.

The driver unit 420 includes a display driver 421 and a rotation driver 422. The display driver 421 drives the display unit 410, e.g., OLEDs, based on a signal output by the controller 430. The display driver 421 transmits power to the display unit 410, creates graphic data in a predetermined standard based on the signal output by the controller 430, and drives the display unit 410 to display the graphic data.

The rotation driver 422 rotates the display unit 410 at a predetermined angular velocity within a predetermined period. The rotation driver 422 includes a rotation connector and a rotation means as in FIG. 1A, or may only include the rotation means. The rotation means may be implemented with known servos or motors, but embodiments of the present invention are not limited thereto.

The controller 430 includes an image analyzer 431, a coordinate representation unit 432, a flat screen converter 433, and a timing mapper 434.

The image analyzer 431 analyzes an input image having 3D display information input through the interface unit 440, and extracts the 3D display information. The image analyzer 431 decodes the input image encoded according to a predetermined standard, and extracts the 3D display information from the decoded input image.

The coordinate representation unit 432 represents the input image in voxel coordinates based on the extracted 3D display information. The 3D image represented in the coordinates is illustrated with respect to FIG. 3A.

The flat screen converter 433 converts the single 3D frame image into at least one 2D subframe image based on the voxel coordinates of the 3D image. The at least one 2D subframe image transformed by the flat screen converter 433 is illustrated with respect to FIGS. 3B to 3D.

The timing mapper 434 timely maps the transformed at least one 2D subframe image. For example, the timing mapper 434 determines display timings by mapping the first to third 2D subframe images, as illustrated in FIGS. 3B to 3D, to first to third timings.

The interface unit 440 receives the input image having the 3D display information. The interface unit 440 is implemented with a direct input means, such as a USB port, or in the form of a module for receiving broadcast data transmitted from the outside. The controller 430 may also perform the foregoing process by using an image stored in a storage as the input image.

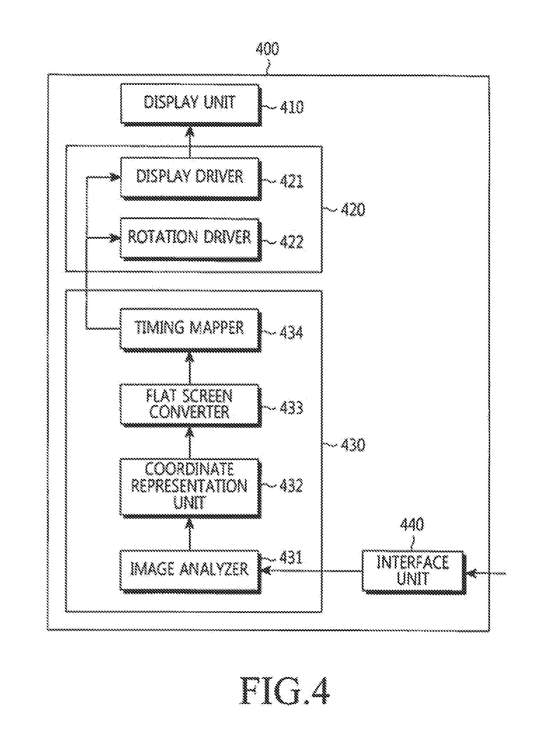

FIG. 5 is a block diagram illustrating a 3D display apparatus, according to another embodiment of the present invention.

The 3D display apparatus includes a display unit 510, a driver unit 520, a rotation connector 530, and a fixed driver 540.

The display unit 510 is formed of a transparent material and performs 2D display, as described above with respect to FIG. 1A or FIG. 2.

The driver unit 520 includes a display driver 521, an auxiliary power generator 522, a deserializer 523, and a synchronizer 524.

The display driver 521 creates graphic data according to a predetermined standard, based on the signal output by the controller 550, and drives the display unit 510 to display the graphic data. Specifically, the display driver 521 creates the graphic data based on a signal input by the deserializer 523, which deserializes a serialized signal output by the controller 550.

The auxiliary power generator 522 directly creates power required for operations of the driver unit 520, or stores the power transmitted from a power source 541. The deserializer 523 deserializes a serialized signal input by a serializer 557. The synchronizer 524 performs synchronization with a synchronizer 543 of the fixed driver 540, based on which the display unit 510 and the driver unit 520 may be controlled to rotate with appropriate timing.

The rotation connector 530 enables the display unit 510 and the driver unit 520, which are connected to each other, to be rotated at a predetermined angular velocity and a cycle. The rotation connector 530 is implemented as a means for connecting the fixed driver 540 and the driver unit 520, and delivers a control signal output by the fixed driver 540 to the display unit 510. The rotation connector 530 relays the signal wiredly or wirelessly, and may be implemented with a slip ring in an embodiment of the present invention.

The fixed driver 540 includes the power source 541, a motor unit 542, the synchronizer 543, a controller 550, and an interface unit 560.

The power source 541 stores or supplies power required for operations of the fixed driver 540. The power source 541 may be implemented as a separate power storage, e.g., a battery-like means, or as a means for receiving external power.

The motor unit 542 is physically coupled with the rotation connector 530 and rotates the rotation connector 530 at a predetermined angular velocity and a cycle. The motor unit 542 is implemented as a means for making rotational motion of a servo or a motor.

The synchronizer 543 performs synchronization with the synchronizer 524 of the driver unit 520, based on which the display unit 510 and the driver unit 520 are controlled to rotate with an appropriate timing. For example, the synchronizer 543 is implemented with a position sensor, such as a photo diode, or performs the synchronization by receiving a light signal emitted by the synchronizer 524 of the driver unit 520. The synchronizer 543 may also be implemented with a light signal generator.

The controller 550 includes an image analyzer 553, a coordinate representation unit 554, a flat screen converter 555, a timing mapper 556, a serializer 557, and a synch generator 558.

The image analyzer 553 includes a 3D display information extractor 552 and an image source selector 551. The image source selector 551 selects an image to be used as a display source from among images input through the interface unit 560, and decodes an input image encoded according to a predetermined method. The 3D display information extractor 552 extracts the 3D display information from the decoded input image.

The coordinate representation unit 554, the flat screen converter 555, and the timing mapper 556 are described in detail above with respect to FIG. 4.

The serializer 557 serializes, and outputs to the deserializer 523, an output signal from the timing mapper 556. The serializer 557 may be embodied as a USB port.

The sync generator 558 generates a signal for synchronization of the synchronizer 543. For example, the sync generator 558 controls the clock frequency of the sync signal output by the synchronizer 543 by producing a clock signal with a predetermined frequency.

The interface unit 560 receives an input image having the 3D display information. The interface unit 560 may be implemented with a direct input means, such as a USB port, or in the form of a module for receiving external broadcast data.

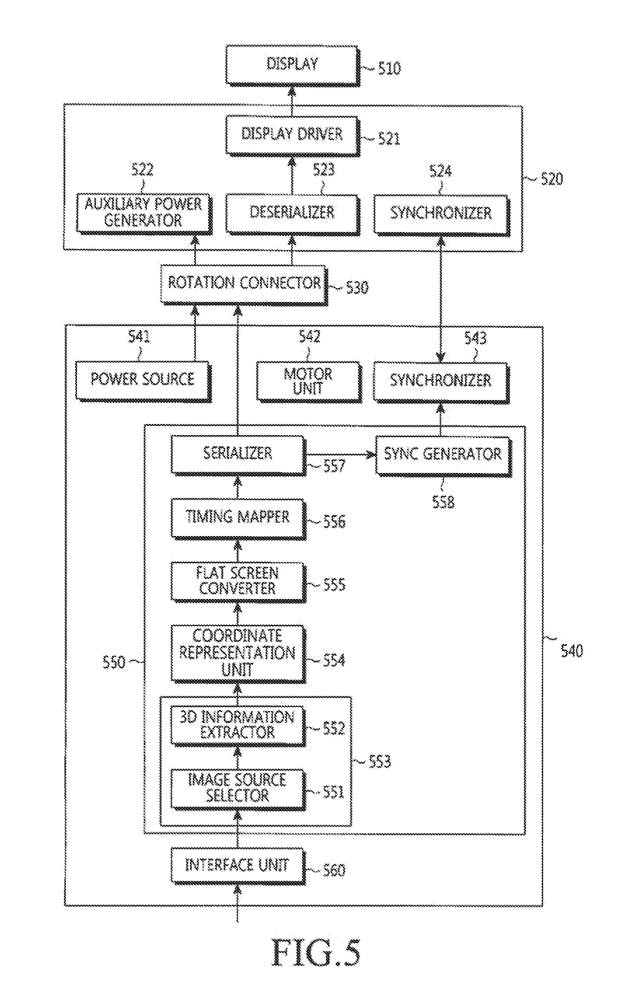

FIG. 6 is a block diagram illustrating a 3D display apparatus, according to another embodiment of the present invention.

Referring to FIG. 6, the 3D display apparatus includes a display unit 610, a driver unit 620, and a fixed driver 630. In contrast to the embodiment of the present invention described with respect to FIG. 5, the 3D display apparatus of FIG. 6 has no rotation connector.

A motor unit 632 is directly coupled with the driver unit 620. Instead of a rotation connector of FIG. 5 that relays signals, a wireless transmitter 633 and a wireless receiver 624 perform signal transmission and reception, respectively.

The wireless transmitter 633 and the wireless receiver 624 may be implemented in the form of a predetermined communication module, such as, for example, Bluetooth®, short-range, infrared, ultraviolet communication module, or like.

A description of a display driver 621, an auxiliary power generator 622, a desrializer 623, a synchronizer 625, a power source 631, a synchronizer 634, a controller 640, an image source selector 641, a 3D information extractor 642, an image analyzer 643, a coordinate representation unit 644, a flat screen converter 645, a timing mapper 646, a serializer 647, a synch generator 648, and an interface unit 650 of FIG. 6, is provided above with respect to the corresponding components of FIG. 5.

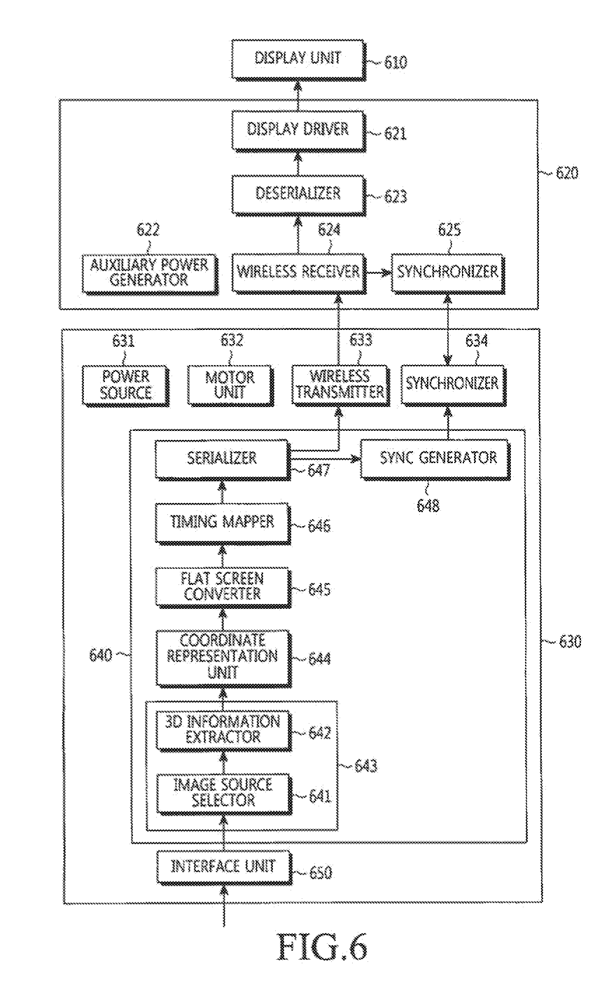

FIG. 7 is a diagram illustrating synchronization, according to an embodiment of the present invention. Referring to FIG. 7, synchronizers included in the driver (i.e., 520 of FIGS. 5 and 630 of FIG. 6) and the fixed driver (i.e., 540 of FIGS. 5 and 630 of FIG. 6) transmit or receive a signal (a) for synchronization as clock signals with a cycle corresponding to a predetermined clock frequency.

The display unit displays at least one 2D subframe image (b) during a time (a period) between clocks.

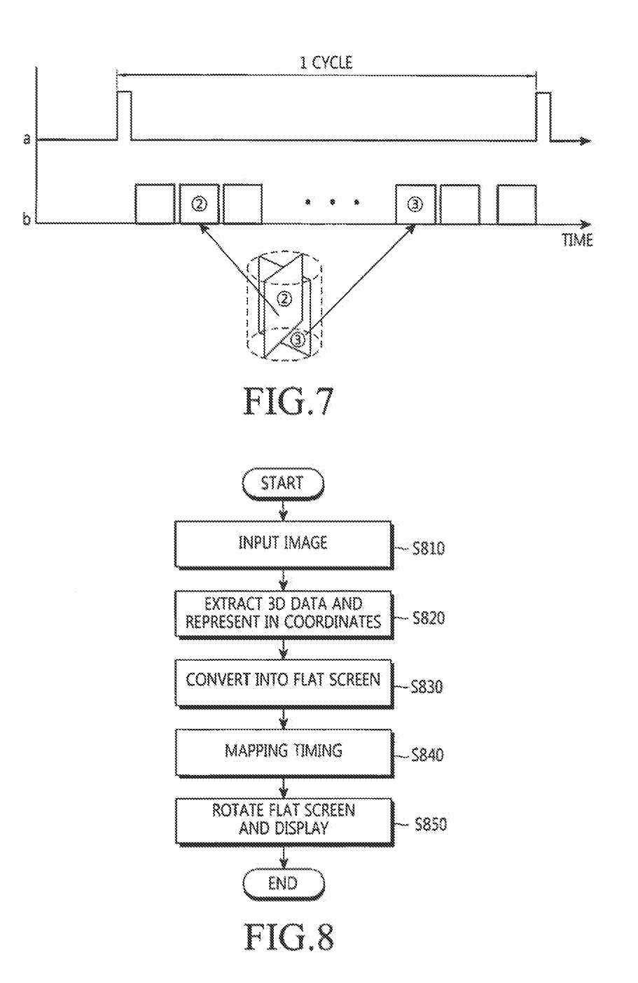

FIG. 8 is a flowchart illustrating a method of controlling the 3D display apparatus, according to another embodiment of the present invention.

The 3D display apparatus receives an input image having the 3D display information, in step S810. The 3D display apparatus receives the input image through a direct input means, such as a USB port, or receives external broadcast data transmitted through a communication module.

The 3D display apparatus analyzes the input image, extracts the 3D display information, and represents the input image in voxel coordinates based on the extracted 3D display information, in step S820.

The 3D display apparatus converts a single 3D frame image into at least one 2D subframe image based on the voxel coordinates, in step S830. The transformation of the 3D frame image into at least one 2D subframe image in the 3D display apparatus is described above with respect to FIGS. 3A to 3D.

The 3D display apparatus determines display timings for the transformed at least one 2D subframe image, and maps each of the at least one 2D subframe image to a respective display timing, in step S840.

The 3D display apparatus displays the at least one 2D subframe image at respective display timings while rotating a 2D flat display means, in step S850, thus creating a 3D frame image.

According to embodiments of the present invention, a volumetric 3D display apparatus and method of displaying volumetric 3D images is provided. The 3D display apparatus significantly reduces an accommodation error because a real image exists in a position where a virtual image exists. The present invention adopts the OLEDs as display means, which eliminates the need for a high performance projector and a control mirror, thus having the advantage of forming high resolution images at lower cost in simpler way than the conventional method.

While the invention has been shown and described with referece to certain embodiments thereof, it will be understood by those skilled in the art that various changes in form and detail may be made therein without departing from the spirit and scope of the invention as defined by the appended claims.

What is claimed is:

1. A Three-Dimensional (3D) display apparatus, comprising:
a display unit formed of a transparent material for displaying a Two-Dimensional (2D) image;
an interface unit for receiving an input image that comprises 3D display information;
a rotation driver coupled to the display unit for rotating the display unit at a predetermined angular velocity within a predetermined period; and
a controller for transforming the 3D display information into at least one piece of 2D display information by analyzing the input image, and controlling the display unit to display at least one 2D subframe image while the display unit is rotating.

2. The 3D display apparatus of claim 1, wherein the controller comprises an image analyzer for decoding the input image using a predetermined method and for extracting the 3D display information from the decoded input image.

3. The 3D display apparatus of claim 2, wherein the controller comprises a coordinate representation unit for representing the 3D display information in voxel coordinates.

4. The 3D display apparatus of claim 3, wherein the controller comprises a flat screen converter for transforming information of the voxel coordinates into at least one piece of information of 2D pixel coordinates.

5. The 3D display apparatus of claim 4, wherein the information of the voxel coordinates is represented in a cylindrical coordinate system, and
wherein the flat screen converter creates the at least one 2D subframe image that represents the 2D pixel coordinates corresponding to the voxel coordinates when an absolute value of a difference between an angle of the voxel coordinates and a display angle of the 2D pixel coordinates is less than or equal to 90°.

6. The 3D display apparatus of claim 5, wherein the flat screen converter determines coordinates of a pixel of the at least one 2D subframe image at a display angle θ, which corresponds to voxel coordinates (r1,θ1,z1), to be (r1 cos(θ−θ1),z1).

7. The 3D display apparatus of claim 4, wherein the controller comprises a timing mapper for mapping display timings of the at least one 2D subframe image to the at least one 2D subframe image.

8. A Three-Dimensional (3D) display apparatus, comprising:
a display unit formed of a transparent material for displaying a Two-Dimensional (2D) image;
a driver unit for creating and outputting the 2D image to the display unit by generating graphic data according to a predetermined standard; and
a fixed driver for rotating the display unit at a predetermined angular velocity, transforming 3D display information of an input image into at least a piece of 2D display information by analyzing the input image, and outputting at least one 2D subframe image to the display unit so that the display unit displays the at least one 2D subframe image based on the 2D display information while the display unit is rotating.

9. The 3D display apparatus of claim 8, wherein the fixed driver comprises a motor unit for rotating a rotation connector at the predetermined angular velocity.

10. The 3D display apparatus of claim 8, further comprising a rotation connector coupled to the fixed driver and the display unit for relaying the at least one 2D subframe image from the fixed driver to the display unit.

11. The 3D display apparatus of claim 8, wherein the fixed driver comprises a first synchronizer for performing synchronization between the driver unit and the fixed driver, and
wherein the driver unit comprises a second synchronizer for performing synchronization between the driver unit and the fixed driver.

12. The 3D display apparatus of claim 11, wherein the first synchronizer comprises a photo diode, and wherein the second synchronizer comprises a light signal generator.

13. The 3D display apparatus of claim 8, wherein the fixed driver comprises a wireless transmitter for transmitting the at least one 2D subframe image, and wherein the driver unit comprises a wireless receiver for receiving the at least one 2D subframe image.

14. A method of controlling a Three-Dimensional (3D) display apparatus including a display unit formed of a transparent material for displaying a Two-Dimensional (2D) image, the method comprising the steps of:
receiving an input image that comprises 3D display information;
transforming the 3D display information into at least one piece of 2D display information by analyzing the input image; and
displaying at least one 2D subframe image based on the 2D display information while the display unit is rotating.

15. The method of claim 14, wherein transforming the 3D display information into the at least one piece of 2D display information, comprises:
analyzing the input image by decoding the input image using a predetermined method and extracting the 3D display information from the decoded input image.

16. The method of claim 15, wherein transforming the 3D display information into the at least one piece of 2D display information, further comprises:
representing the 3D display information in voxel coordinates.

17. The method of claim 16, wherein transforming the 3D display information into the at least a piece of 2D display information, further comprises:
transforming information of the voxel coordinates into at least a piece of information of 2D pixel coordinates.

18. The method of claim 17, wherein the information of the voxel coordinates is represented in a cylindrical coordinate system, and
wherein the at least one 2D subframe image that represents the 2D pixel coordinates corresponding to the voxel coordinates is created when an absolute value of a difference between an angle of the voxel coordinates and a display angle of the 2D pixel coordinates is less than or equal to 90°.

19. The method of claim 18, wherein coordinates of a pixel of the at least one 2D subframe image at a display angle θ, which corresponding to voxel coordinates (r1,θ1,z1), is determined to be (r1 cos(θ−θ1),z1).

20. The method of claim 17, wherein transforming the 3D display information into the at least a piece of 2D display information comprises mapping display timings of the at least one 2D subframe image to the at least one 2D subframe image.
